(19) United States
(12) Patent Application Publication
(10) Pub. No.: US 2026/0291335 A1
(43) Pub. Date: Sep. 24, 2026

(54) ELECTRIC MACHINE WITH INTEGRATED COOLING AND DEVICE WITH ELECTRIC MACHINE

(71) Applicant: Gardner Denver Deutschland GmbH, Bad Neustadt an der Saale (DE)

(72) Inventors: Christian Günther, Bad Neustadt an der Saale (DE); Arthur Michaux, Bad Neustadt an der Saale (DE); Evgenij Borisovic Rjabchenko, Bad Neustadt an der Saale (DE); Anil Berk Atalar, Bad Neustadt an der Saale (DE); Mario Kempf, Bad Neustadt an der Saale (DE); Florian Diller, Bad Neustadt an der Saale (DE)

(21) Appl. No.: 19/573,677

(22) Filed: Mar. 20, 2026

(30) Foreign Application Priority Data
Mar. 20, 2025 (EP) 25165076.8

(51) Int. Cl. H02K 9/10; H02K 7/00; H02K 9/06

(52) U.S. Cl. CPC H02K 9/10; H02K 7/003; H02K 9/06

(57) ABSTRACT

An electric machine is with integrated cooling is disclosed herein. In embodiments, the electric machine includes a rotor, a stator, fluid channels in the stator, and a first fluid space in which a cooling disk is rotatably arranged. The rotor includes a hollow shaft, an impeller, and the cooling disk, which is arranged between a first end of the hollow shaft and the impeller. As a result of rotation of the rotor, the cooling disk is configured to draw in fluid through the hollow shaft and conveys the fluid through the cooling disk, the first fluid space and further through the fluid channels.

### TECHNICAL FIELD

The present disclosure relates to an electric machine with cooling. Furthermore, the present disclosure relates to a device including at least one electric machine.

### BACKGROUND

Electric machines have been known for a long time. A fan attached to the rotor is usually used for cooling. A disadvantage of the electric machines is that the efficiency of the cooling is often insufficient and cooling devices are associated with high maintenance and repair costs. Furthermore, high temperature gradients occur which, for example, can have a harmful effect on the ball bearings, which then leads to bearing damage or bearing failure.

### SUMMARY

Embodiments of the present disclosure describe an electric machine with integrated cooling or cooling device, with a rotor comprising a hollow shaft, an impeller and a cooling disk which is arranged between a first end of the hollow shaft and the impeller, a stator, fluid channels in the stator, and a first fluid space in which the cooling disk is rotatably arranged, wherein, in order to form a cooling circuit, the electric machine comprises, in addition to the hollow shaft, the cooling disk, the first fluid space and the fluid channels, and wherein, as a result of rotation of the rotor, the cooling disk is designed to draw in or to suck fluid through the hollow shaft and to convey it through the cooling disk, the first fluid space and further through the fluid channels.

In other words, as a result of rotation of the rotor, the cooling disk is designed to draw in or to suck fluid through the hollow shaft and to convey it further through the stator. The resulting intake results from the flow mechanics according to Euler’s work or Euler’s equation.

A hollow shaft can be understood to mean a rotor shaft or shaft with an axial bore. In embodiments, the hollow shaft is of hollow-cylindrical or hollow-cylinder-shaped form.

A cooling disk can be understood to mean a disk which has radially guided passage openings. It is thereby possible to convey fluid through the cooling disk. As a result of rotation of the rotor, the cooling disk can be designed to be fluid-sucking or fluid-conveying. In other words, the cooling disk benefits from a suction effect. Furthermore, the cooling disk can generate cooling or cooling-down over its surface.

An impeller can be understood to mean a running wheel. The impeller can comprise radially arranged blades or a ring of blades.

The impeller is connected to the first end of the hollow shaft via the cooling disk. The components can be detachably connected to one another. Alternatively, the components can be non-detachably connected to one another. In some embodiments, they connected to one another in a form-fitting and/or force-fitting manner. In some embodiments, the impeller, the cooling disk and the first hollow shaft form a coupling.

A rotor can be understood to mean the rotating or turning part of an electric machine. Furthermore, the rotor can be understood to mean a runner. A stator can be understood to mean a stationary, immovable part of an electric machine. The stator is thus in contrast to the mechanically movable part, the rotor. In embodiments, the stator comprises the coil(s) or induction coil(s) and the rotor comprises the magnet or magnets or vice versa. In embodiments, the electric machine is an induction motor.

If the rotor is in rotation, the electric machine is in the operating state or in the activated state.

A fluid can be understood to mean air, a gas, a gas mixture or a liquid. A fluid channel can be understood to mean a line or fluid conveying line for conveying fluid. Conveying fluid can be understood to mean conducting fluid or forwarding fluid.

A fluid space can be understood to mean a section in the stator which is designed to forward or further convey the fluid out of the cooling disk. In embodiments, the fluid space is a cooling space.

Conveying can be understood to mean drawing in, forwarding or transporting. Drawing in through the hollow shaft can be understood to mean drawing in or conveying fluid from a second end of the hollow shaft in the direction of the first end of the hollow shaft.

In embodiments, a cooling sleeve is arranged between the cooling disk and the hollow shaft. The cooling sleeve can be designed to decouple the cooling disk and the hollow shaft from the impeller. Furthermore, the cooling sleeve can be designed to decouple warmth-sensitive or heat-sensitive components, such as shaft ring seals or ball bearings. Furthermore, the cooling sleeve, which is in contact with the cooling disk, can be designed to contribute to the additional cooling-down of the adjacent components. In emboidments, the cooling sleeve has openings in order to enable conveying of fluid from the hollow shaft to the cooling disk.

With the cooling disk of the electric machine, it is possible, on the one hand, to cool down the rotor shaft and sensitive rotor components, such as magnets or ball bearings. On the other hand, the cooling disk decouples a possibly very hot impeller from the shaft. Cooling of the warmed or heated fluid then takes place, in particular, in the cooler stator.

By means of the electric machine, it is also possible to transfer the heat or warmth absorbed by the impeller as a result of external temperature action on the impeller to the cooling disk and consequently to the passing fluid, in order, as a result of rotation of the rotor, to lower the temperature within the electric machine, in particular the rotor shaft and the sensitive rotor components, such as magnets and ball bearings, to a tolerable temperature level. A tolerable temperature level can be understood to mean a temperature range up to 100° C.

In a first embodiment, the electric machine comprises, in order to form a closed cooling circuit, a second fluid space which is arranged at ends of the fluid channels, and wherein, as a result of rotation of the rotor, the cooling disk is further designed to convey the fluid through the fluid channels or out of the fluid channels further through the second fluid space and back through the hollow shaft.

Alternatively, at each end of the fluid channels, an outlet opening and at least one inlet opening are arranged in or on a cover of the electric machine, wherein in each case one line connects an outlet opening to the inlet opening and wherein, as a result of rotation of the rotor, the cooling disk is further designed to convey the fluid out of the fluid channels through the respective line and from the line further through the hollow shaft.

As a result, it is possible to generate a cooling circuit which is closed per se and permits fluid circulation in the rotor and in the stator, in order to cool, in particular, the rotor shaft and the sensitive rotor components, such as magnets and ball bearings.

In embodiments, an inlet opening is sufficient to join or couple all lines thereto.

As mentioned above, as a result of rotation of the rotor, the cooling disk is designed to draw in or to suck fluid through the hollow shaft. In embodiments, the second fluid space is connected to the second end of the hollow shaft.

In an alternative embodiment, the electric machine, in order to form an open cooling circuit, comprises outlet openings and at least one inlet opening in a cover of the electric machine, wherein, as a result of rotation of the rotor, the cooling disk is further designed to convey the fluid out of the electric machine through the fluid channels or to convey the fluid out of the fluid channels further through the outlet openings which are arranged at ends of the fluid channels or in or on the cover, and to convey or draw in fresh fluid from outside the electric machine through the hollow shaft through at least one inlet opening.

It is thereby possible to generate a cooling circuit which is open. When conveying the fluid out of the electric machine according to the first alternative, a bore through the stator can be dispensed with. According to the second alternative, fluid circulation in the rotor and in the stator is permitted, wherein fresh air is supplied via the at least one inlet opening, in order to cool, in particular, the rotor shaft and the sensitive rotor components, such as magnets and ball bearings.

The outlet opening serves for the fluid to be conveyed out of the electric machine. The inlet opening serves for further fresh fluid to be conveyed or drawn into the electric machine.

Fresh fluid is understood to mean a fluid which does not correspond to the fluid which has been discharged or ejected from the electric machine. In particular, fresh fluid can be understood to mean a fluid from outside the machine or a fluid which has a temperature which is lower than that of the fluid which leaves the electric machine via the outlet opening.

In embodiments, the hollow shaft is arranged between the first cavity and the second cavity and the fluid channels connect the cavities.

In a further embodiment, the cooling disk is designed to discharge or to transfer waste heat which arises on the impeller as a result of external action of heat or warmth to the fluid, wherein the cooling disk, as a result of rotation of the rotor, the first fluid space, the fluid channels and/or the second fluid space are designed to cool down the heated or warmed fluid, and in some instances, to cool it down incrementally.

It is thereby possible to absorb the waste heat from the fluid and to transport it away or carry it away for cooling. Waste heat on the impeller can arise from external action of heat or warmth on the impeller and/or, in particular, during operation with a recirculation blower for fuel cells. Here, the fluid or gas which is in contact with the impeller can have temperatures of up to 200° C, and in some instances up to 250° C.

Occasionally, the region at the first end of the hollow shaft can also experience or absorb warming. In embodiments, the cooling sleeve is arranged between the cooling disk and the hollow shaft in order to reduce warming.

In a further embodiment, the fluid channels are arranged parallel to the hollow shaft in the electric machine. In other words, a longitudinal extent of the fluid channels is parallel to the longitudinal extent of the hollow shaft.

Alternatively, the fluid channels can be arranged orthogonally or obliquely to the hollow shaft in the electric machine, such as in the stator. Obliquely can be understood to mean an obtuse or acute angle which the fluid channels form with the hollow shaft.

In one embodiment, the number of fluid channels is greater than/equal to 2. In other embodiments, greater than/equal to 12. In other embodiments, greater than/equal to 18.

In a further embodiment, the cooling disk has radial fluid inlet openings and radial and/or axial fluid outlet openings.

By means of the radially arranged fluid inlet openings, it is possible to radially draw in the fluid which is located in the hollow shaft and to convey the fluid out of the cooling disk. By means of the axially arranged fluid outlet openings, it is possible to convey the fluid out of the cooling disk and at the same time to generate an intensified cooling effect on the surface of the cooling disk. In embodiments, the axial fluid outlet openings are arranged at the edge of the cooling disk. In embodiments, the cooling disk has axial fluid outlet openings on both sides. The cooling effect on the surface of the cooling disk can thereby be additionally improved.

In embodiments, the impeller has radially arranged baffle plates, blades or guide elements.

In a further embodiment, as a result of rotation of the rotor, the cooling disk is designed to produce or generate conveying of fluid resulting from Euler's work or Euler's equation.

The cooling disk thus makes use of the rotation of the rotor. Pressure builds up from the inside to the outside via Euler’s work (specific work = delta(circumferential speed of the air*circumferential speed of the cooling disk)). The fluid is thereby sucked through the shaft and forced back through the fluid channels through the stator. In sum, the electric machine thus increases the heat transfer from the rotating system into the non-rotating system and thermally decouples hot rotor components from the sensitive rotor components (such as, for example, magnets, ball bearing inner ring, ball bearing grease).

In a further embodiment, the electric machine is designed to reduce or to cool down a temperature in the range of up to 180° C in the region of the cooling disk, as a result of waste heat which arises on the impeller as a result of external action of heat or warmth, to up to 60° C in the fluid channels and, in some embodiments, in at least one of the fluid spaces, and, in further embodiments, in the hollow shaft.

Sufficient cooling-down for the sensitive components of the rotor can thereby be achieved. Reduction can take place incrementally or continuously.

As disclosed herein, a device including at least one electric machine, as described above, can also have a recirculation blower for fuel cells. When the electric machine is used in a recirculation blower for fuel cells, a high temperature in the range of approximately 180°C can occur on the impeller. By means of the electric machine, it is possible to discharge the warmth absorbed by the impeller to the cooling disk and consequently to the passing fluid, in order, as a result of rotation of the rotor, to lower the temperature within the electric machine, in particular the rotor shaft and the sensitive rotor components, such as magnets and ball bearings, to a tolerable temperature level. A tolerable temperature level can be understood to mean a temperature range of up to 100°C.

At least one of the above embodiments provides one or more solutions. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment or embodiments.

### BRIEF DESCRIPTION OF THE DRAWINGS

The disclosure will be further described with reference to examples depicted as schematic illustrations in the accompanying figures, in which:

FIG. 1 is an electric machine in a sectional depiction, according to embodiments of the present disclosure;

FIG. 2 is an electric machine, such as the electric machine of FIG. 1, with a closed fluid circuit, according to embodiments of the present disclosure;

FIG. 3 is an electric machine, such as the electric machine of FIG. 1, with a closed fluid circuit, according to embodiments of the present disclosure;

FIG. 4 is an electric machine with a closed fluid circuit, according to embodiments of the present disclosure;

FIG. 5 is an electric machine with an open fluid circuit, according to embodiments of the present disclosure;

FIG. 6 is an electric machine, such as the electric machine of FIG. 1, with details A and B;

FIG. 7 depicts detail A from FIG. 6; and

FIG. 8 depicts detail B from FIG. 6.

### DETAILED DESCRIPTION

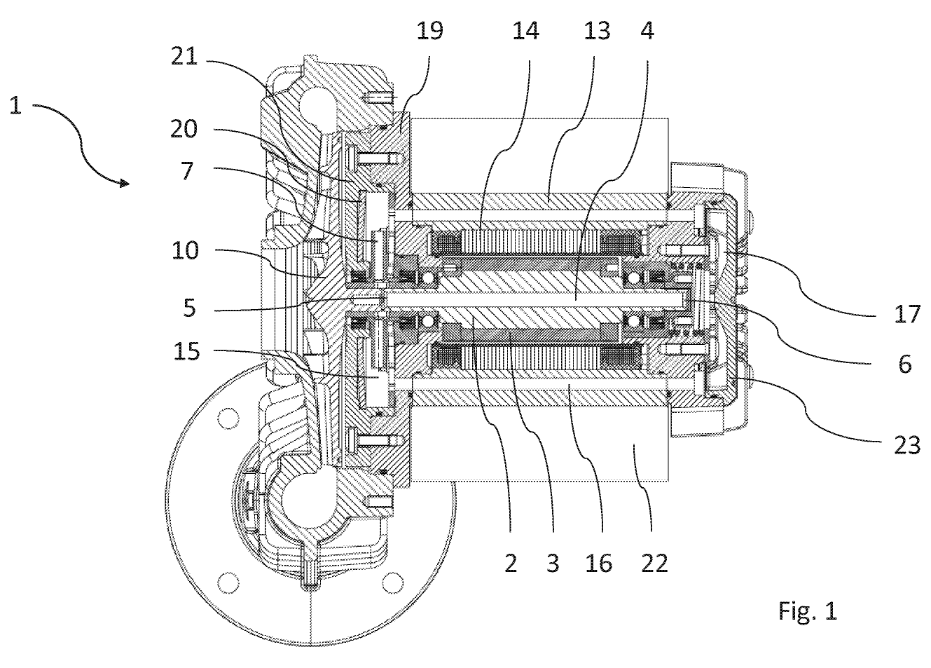

FIG. 1 shows a sectional depiction of an embodiment of the electric machine 1 according to the present disclosure. The electric machine 1 has a rotor 2 with magnets 3 and a stator 13 with coils 14.

The rotor 2 comprises a shaft which is in the form of a hollow shaft 4. The hollow shaft 4 is rotatably mounted in the electric machine 1. The hollow shaft 4 is of hollow-cylindrical form. The rotor 2 furthermore comprises an impeller 10 and a cooling disk 7. The cooling disk 7 is arranged between a first end 5 of the hollow shaft 4 and the impeller 10. Here, both the impeller 10, the cooling disk 9 and also the hollow shaft 4 are connected to one another. The connection of the three components can be understood to mean a fixed coupling. In embodiments, the components are connected to one another in a detachable or alternatively non-detachable manner.

Fluid channels 16 are arranged in the stator 13. Furthermore, the electric machine 1 has a first fluid space 15. The cooling disk 7 is rotatably arranged in the first fluid space 15.

Furthermore, the electric machine 1 has a bearing end shield 19, a disk 20 and a first cover 21. The first fluid space 15 is arranged between the bearing end shield 19 and the disk 20. As already mentioned above, the cooling disk 7 is located in the first fluid space 15. The first cover 21 is arranged between the bearing end shield 19 and the impeller 10. A second cover 23 closes off the electric machine 1 towards the other side.

In order to form a cooling circuit, the electric machine 1 comprises, in addition to the hollow shaft 4, the cooling disk 7, the first fluid space 15 and the fluid channels 16. In particular, air is used as fluid. However, a gas, a gas mixture or a liquid can also be used.

The rotor 2 is designed, in the operating state with a rotating cooling disk 7, to draw in fluid through the hollow shaft 4 from a second end 6 of the hollow shaft 4 in the direction of the first end 5 of the hollow shaft 4 and to convey it further to the fluid channels 16. The corresponding intake results from the flow mechanics according to Euler's work or Euler's equation.

It goes without saying that rotation of the rotor 2 is accompanied by rotation of the impeller 10, the cooling disk 7 and the hollow shaft 4. The impeller 10 has radially arranged baffle plates, blades or guide elements.

Furthermore, the electric machine 1 can have a second fluid space 17 in order to form a closed cooling circuit. The second fluid space 17 is arranged at the ends of the fluid channels 16. As a result of the rotation of the rotor 2 and therefore of the cooling disk 7, the cooling disk 7 is further designed to convey the fluid through the cooling disk 7, the first fluid space 15, the fluid channels 16, the second fluid space 17 and the hollow shaft 4.

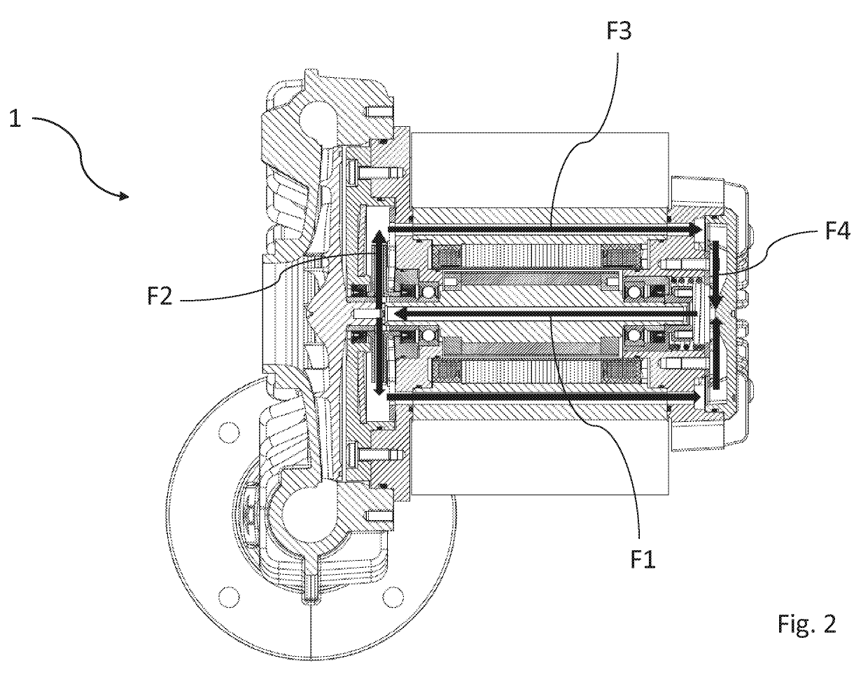

It is thereby possible to generate a cooling circuit which is internally closed and permits fluid circulation in the rotor 2 and in the stator 13, in order to cool, in particular, the rotor shaft 4 and the sensitive rotor components, such as magnets and ball bearings. A closed cooling circuit is shown in FIG. 2, for example.

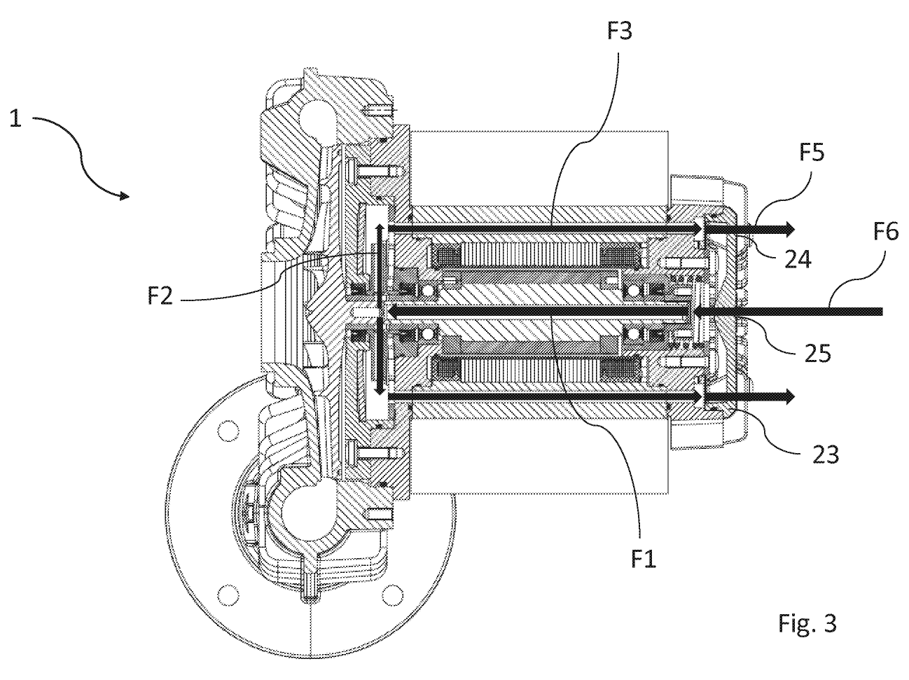

Alternatively, in order to form an open cooling circuit, the electric machine 1 can have outlet openings 24 and at least one inlet opening 25 in the second cover 23 of the electric machine 1 (reference to FIG. 3). As a result of rotation of the rotor 2, the cooling disk 7 is further designed to convey the fluid through the cooling disk 7, the first fluid space 15, the fluid channels 16 and out of the outlet openings 24 which are arranged at ends of the fluid channels 16 in the cover 23. Furthermore, as a result of rotation of the rotor 2, the cooling disk 7 is further designed to draw in fresh fluid from outside the electric machine 1 through the hollow shaft 4 through at least one inlet opening 25.

It is thereby possible to generate a cooling circuit which is open and permits fluid circulation in the rotor 2 and in the stator 13, wherein fluid is discharged via the outlet opening 24 and fluid is introduced, for example in the form of a fresh air supply, via the inlet opening 25, in order to cool, in particular, the rotor shaft 4 and the sensitive rotor components, such as magnets and ball bearings.

Fresh fluid can be understood to mean a fluid from outside the machine or a fluid which has a temperature which is lower than that of the fluid which leaves the electric machine 1 via the outlet opening 24. An open cooling circuit is shown in FIG. 3.

The cooling disk 7 is designed to discharge waste heat, which arises on the impeller 10 as a result of external action of heat or warmth, to the fluid. At the cooling disk 7, temperatures of further above 100°C can occur, which have to be reduced by the circulating fluid flow. The cooling disk 7 which is rotatiing, the first fluid space 15, the fluid channels 16 and the second fluid space 17 are designed to cool down the heated fluid incrementally.

The fluid channels 16 are arranged parallel to the hollow shaft 4 in the electric machine 1.

Although only 2 fluid channels 16 are shown in the section, in the present case at least 12 fluid channels 16 are arranged in the stator 13 of the electric machine in order to achieve sufficient cooling of the fluid.

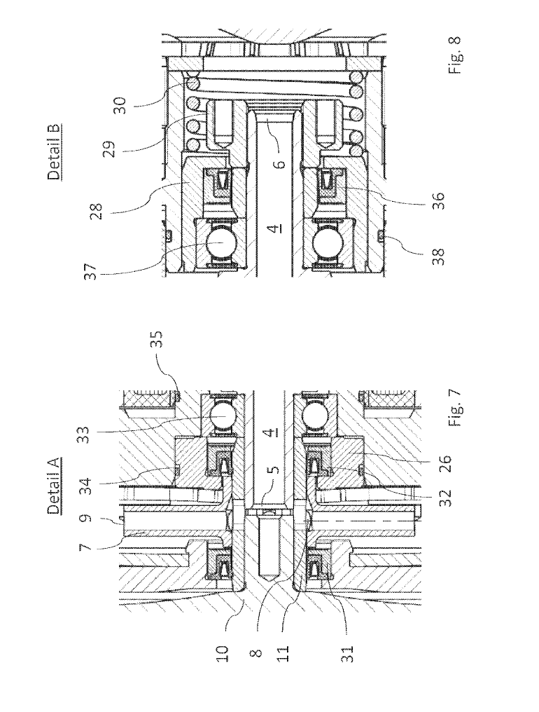

The cooling disk 7 has radial fluid inlet openings 8 (reference to FIG. 7) and radial (reference to FIG. 7) fluid outlet openings 9. The fluid flow can thereby be realized in a simple manner. By means of the radially arranged fluid inlet openings 8, the fluid which is located in the hollow shaft 4 is drawn in. By means of the radially arranged fluid outlet openings 9, it is possible to convey the fluid out of the cooling disk 7.

Furthermore, axial fluid outlet openings (not shown) are arranged on the cooling disk 7 on both sides and at the edge of the cooling disk 7. With the axial fluid outlet openings, it is possible to convey the fluid out of the cooling disk 7 and at the same time to generate an intensified cooling effect on the surface of the cooling disk 7.

As a result of the rotation of the rotor 2, the cooling disk 7 is designed to generate conveying of fluid resulting from Euler’s work or Euler’s equation. It is thus possible to draw in the fluid which is located in the hollow shaft 4 and to pass it on accordingly.

In summary, it should be noted that the cooling disk 7 makes use of the rotation of the rotor 2, with pressure building up from the inside to the outside via Euler’s work or Euler’s equation. The fluid is thereby sucked through the hollow shaft 4 and conveyed through the fluid channels 16 through the stator 13.

In sum, the electric machine thus increases the heat transfer from the rotating system into the non-rotating system and thermally decouples hot rotor components from the sensitive rotor components (such as, for example, magnets, ball bearings, ball bearing inner ring, ball bearing grease, etc.).

The electric machine 1 can be designed, for example, to reduce a temperature in the range of up to 180°C in the region of the cooling disk 7, as a result of waste heat which arises on the impeller 10 as a result of external action of heat or warmth, to up to 60°C in the fluid channels 16, and, in some embodiments, at least one of the fluid spaces 15, 17 and in the hollow shaft 4. Sufficient cooling-down for the sensitive components of the rotor 2 can thereby be achieved.

FIG. 2 shows an embodiment of the electric machine with a closed fluid circuit, according to the embodiment of FIG. 1.

The arrow F1 shows the fluid direction through the hollow shaft 4, the arrow F2 shows the fluid direction through the cooling disk 7 and the first fluid space 15, the arrow F3 shows the fluid direction through the fluid channel 16 and the arrow F4 shows the fluid direction through the second fluid space 17 towards the hollow shaft 4. FIG. 2 thus illustrates the closed cooling circuit mentioned above.

FIG. 3 shows a further embodiment of the electric machine with an open fluid circuit or fluid flow, according to the embodiment of FIG. 1.

The arrow F1 shows the fluid direction through the hollow shaft 4, the arrow F2 shows the fluid direction through the cooling disk 7 and the first fluid space 15, the arrow F3 shows the fluid direction through the fluid channel 16, the arrow F5 shows the fluid direction through parts of the second fluid space 17 and/or the outlet opening 24 to the outside of the electric machine 1, whereas the arrow F6 shows the fluid direction through the inlet opening 25 to the hollow shaft 4. FIG. 3 thus illustrates the open cooling circuit mentioned above.

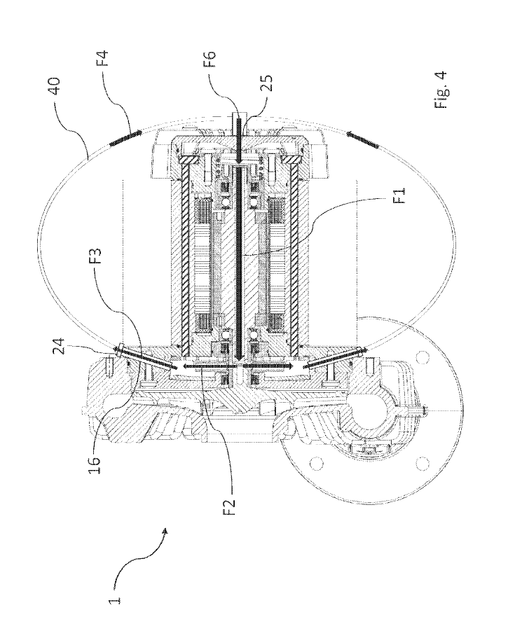

FIG. 4 shows an alternative embodiment of the electric machine according to the embodiment with a closed fluid circuit.

In contrast to FIG. 2, the fluid channel 16 is not guided parallel to the hollow shaft 4. Rather, it runs obliquely through parts of the stator 13. It can also run orthogonally to the hollow shaft 4. An outlet opening 24 is arranged at each end of the fluid channels 16. Furthermore, at least one inlet opening 25 is arranged in the cover 23 of the electric machine 1.

A line 40 connects in each case one outlet opening 24 to the inlet opening 25. All lines are connected to the one outlet opening 24. As a result of rotation of the rotor 2, the cooling disk 7 is further designed to convey the fluid out of the fluid channels 16 further through line 40 and again through the hollow shaft 4.

The arrow F1 shows the fluid direction through the hollow shaft 4, the arrow F2 shows the fluid direction through the cooling disk 7 and the first fluid space 15, the arrow F3 shows the fluid direction through the fluid channel 16 and the arrow F4 shows the fluid direction through the line 14 towards the hollow shaft 4. Since the fluid channels 16 are not connected directly to the second fluid space 17, the second fluid space 17 is of subordinate importance.

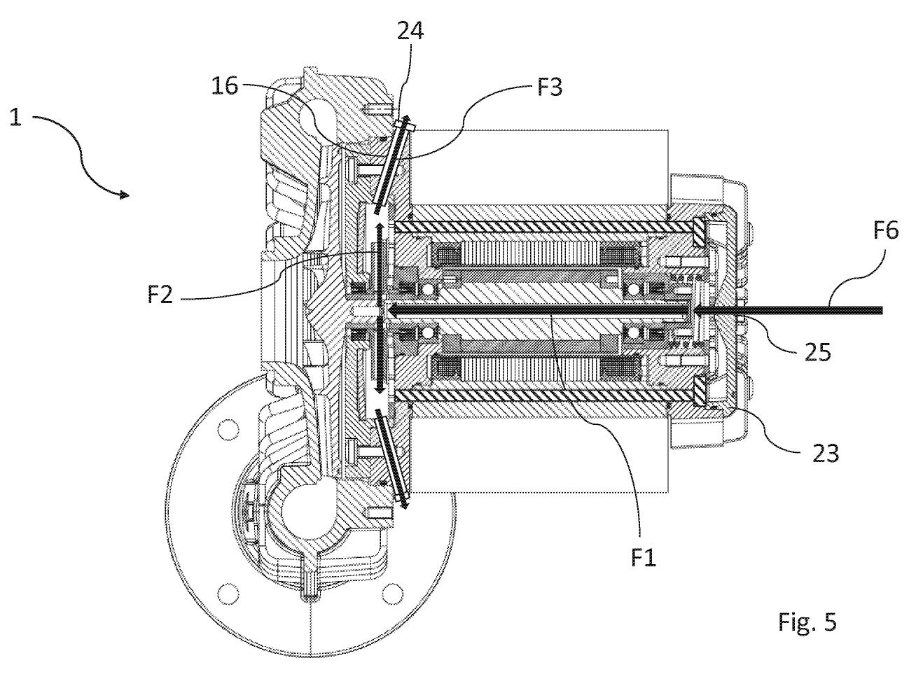

FIG. 5 shows an alternative embodiment of the electric machine with an open fluid circuit or fluid flow.

In contrast to FIG. 4, there is no line 40.

The arrow F1 shows the fluid direction through the hollow shaft 4, the arrow F2 shows the fluid direction through the cooling disk 7 and the first fluid space 15, the arrow F3 shows the fluid direction through the obliquely arranged fluid channel 16 and through the outlet opening 24 to the outside of the electric machine 1, whereas the arrow F6 shows the fluid direction through the inlet opening 25 to the hollow shaft 4. Since the fluid channels 16 are not connected directly to the second fluid space 17, the second fluid space 17 is of subordinate importance.

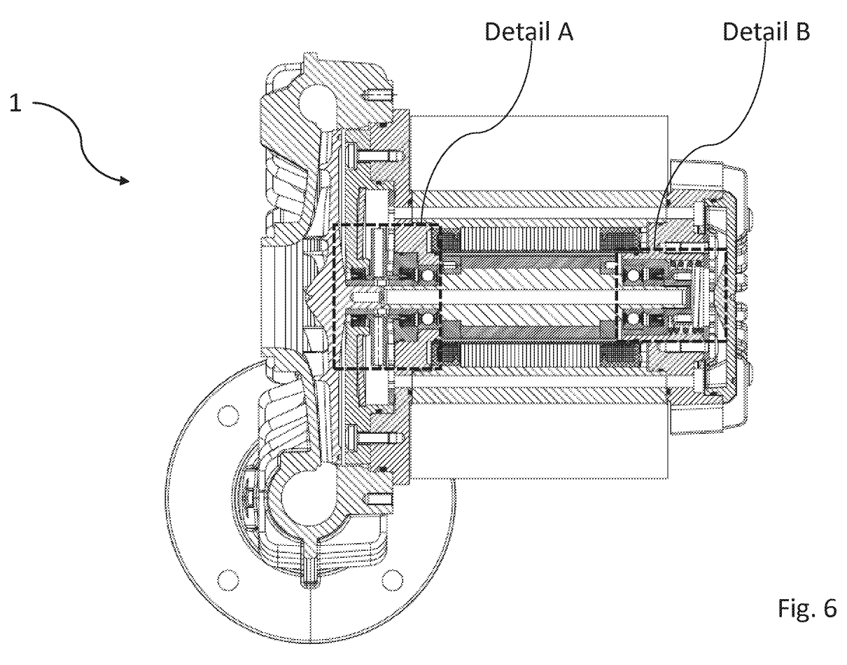

FIG. 6 shows the embodiment of the electric machine according to the emobdiment of FIG. 1 with details A to D.

FIG. 7 shows detail A from FIG. 6. Detail A occasionally shows a first shaft seal 31 and a second shaft seal 32, which are arranged on both sides of the cooling disk 7, and a first ball bearing 33. The first ball bearing 33 serves as a bearing for rotating the hollow shaft 4 of the rotor 2. The first ball bearing 33 is arranged between a section of the hollow shaft 4 and the bearing end shield 19. The first shaft seal 31 is arranged between a section of the hollow shaft 4 and a first sleeve 26. The second shaft seal 32 is arranged between a cooling sleeve 11 and the disk 20. Furthermore, a first O-ring 34 and a second O-ring 35 are shown.

The cooling sleeve 11 is arranged between the cooling disk 7 and the hollow shaft 4. Additional decoupling of the cooling disk 7 and the hollow shaft 4 from the impeller 10 can thereby be brought about. In this case, the cooling sleeve 11 has openings in order to enable conveying of fluid from the hollow shaft 4 to the cooling disk 7. Furthermore, the first and second shaft seals 31, 32 are also decoupled. Furthermore, the cooling sleeve 11, which is in contact with the cooling disk 7, cools the components which are adjacent to it. In embodiments, the cooling sleeve has openings in order to enable conveying of fluid from the hollow shaft to the cooling disk.

The first and second shaft seals 31, 32 and the first ball bearing 33 can be understood to be warmth-sensitive or heat-sensitive rotor components.

FIG. 8 shows detail B from FIG. 6. Detail B occasionally shows a third shaft seal 36 and a second ball bearing 37. The second ball bearing 37 serves as a bearing for rotating the hollow shaft 4 of the rotor 2. The second ball bearing 37 is arranged between a section of the hollow shaft 4 and a bearing sleeve 28. The third shaft seal 36 is arranged between the bearing sleeve 28 and a second sleeve 27. Furthermore, a balancing ring 29, a spring 30, which exerts pressure on the bearing sleeve 28, and a third O-ring 38 are shown.

The third shaft seal 36 and the second ball bearing 37 can be understood to be warmth-sensitive or heat-sensitive rotor components.

### Reference signs

With the electric machine, it is possible, on the one hand, to cool down the rotor shaft and sensitive rotor components, such as magnets or ball bearings. On the other hand, the cooling disk decouples a possibly very hot impeller from the shaft. Cooling of the warmed or heated fluid then takes place, in particular, in the cooler stator.
1 electric machine
2 rotor
3magnet
4 hollow shaft
5 first end
6 second end
7 cooling disk
8 fluid inlet opening
9 fluid outlet opening
10 impeller (running wheel)
11cooling sleeve
12 /
13 stator
14 coil
15 first fluid space
16 fluid channel
17second fluid space
18 /
19 bearing end shield
20 disk
21 cover
22 motor housing
23 cover
24 outlet opening
25 inlet opening
26 first sleeve
27second sleeve
28 bearing sleeve
29 balancing ring
30 spring
31 first shaft seal
32 second shaft seal
33 first ball bearing
34 first O-ring
35 second O-ring
36 third shaft seal
37 second ball bearing
38 third O-ring
39 /
40 line

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the preceding description, it is understood that terms such as “first,” “second,” “top,” “bottom,” “up,” “down,” and the like, are words of convenience and are not to be construed as limiting terms.

In reading the claims, it is intended that when words such as “a,” “an,” “at least one,” or “at least one portion” are used, there is no intention to limit the claim to only one item unless specifically stated to the contrary in the claim. When the language “at least a portion” and/or “a portion” is used, the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. An electric machine, comprising:
a rotor including a hollow shaft, an impeller, and a cooling disk, the cooling disk arranged between a first end of the hollow shaft and the impeller;
a stator that defines one or more fluid channels; and
a first fluid space in which the cooling disk is rotatably arranged,
wherein the hollow shaft, the cooling disk, the first fluid space, and the one or more fluid channels define a cooling circuit, and
wherein, as a result of rotation of the rotor, the cooling disk is configured to draw in fluid through the hollow shaft and convey the fluid through the cooling disk, the first fluid space, and through the one or more fluid channels.

2. The electric machine of claim 1, further comprising:
a second fluid space arranged at the ends of the one or more fluid channels, wherein, as a result of rotation of the rotor, the cooling disk is configured to convey the fluid out of the one or more fluid channels further through the second fluid space and back through the hollow shaft; and
an outlet opening arranged at each end of the one or more fluid channels, and at least one inlet opening arranged in a cover of the electric machine, wherein for each respective outlet opening and each respective inlet opening, a respective line connects the respective outlet opening to the respective inlet opening, and wherein, as a result of rotation of the rotor, the cooling disk is further designed to convey the fluid out the one or more fluid channels further through each respective line and back through the hollow shaft, thus forming a closed cooling ciruit.

3. The electric machine of claim 1, further comprising:
outlet openings and at least one inlet opening in a cover of the electric machine, and wherein as a result of rotation of the rotor, the cooling disk is further configured to:
convey the fluid out of the electric machine through the one or more fluid channels or convey the fluid out of the one or more fluid channels further through the outlet openings, wherein the outlet openings are arranged at ends of the one or more fluid channels or in the cover, and
convey fresh fluid from outside the electric machine through the hollow shaft through at least one inlet opening.

4. The electric machine of claim 1, wherein the cooling disk is configured to discharge waste heat, which arises on the impeller as a result of external action of heat or warmth, to the fluid, and wherein, as a result of rotation of the rotor, the cooling disk, the first fluid space, and the one or more fluid channels are configured to cool down the heated fluid.

5. The electric machine of claim 1, wherein the one or more fluid channels are arranged parallel, orthogonally, or obliquely to the hollow shaft in the electric machine.

6. The electric machine of claim 1, wherein the number of fluid channels is greater than or equal to two.

7. The electric machine of claim 1, wherein the number of fluid channels is greater than or equal to 12.

8. The electric machine of claim 1, wherein the number of fluid channels is greater than or equal to 18.

9. The electric machine of claim 1, wherein the cooling disk has one or more radial fluid inlet openings and one or more radial or axial fluid outlet openings, and wherein the impeller has radially arranged baffle plates, blades, or guide elements.

10. The electric machine of claim 1, wherein, as a result of rotation of the rotor, the cooling disk is configured to convey the fluid as a result of Euler’s work or Euler’s equation.

11. The electric machine of claim 1, wherein the electric machine is configured to reduce a temperature in the range up to 180°C in a region of the cooling disk, as a result of waste heat which arises on the impeller as a result of external action of heat or warmth, to up to 60°C in the one or more fluid channels, and in at least one of the fluid spaces, and in the hollow shaft.
